(19) United States
(12) Patent Application Publication
(10) Pub. No.: US 2021/0178489 A1
(43) Pub. Date: Jun. 17, 2021

(54) DIAMOND-COATED TOOL

(71) Applicant: National University Corporation Tokai National Higher Education and Research System, Nagoya-shi (JP)

(72) Inventor: Eiji SHAMOTO, Nagoya-shi Aichi (JP)

(21) Appl. No.: 17/188,330

(22) Filed: Mar. 1, 2021

Related U.S. Application Data
(63) Continuation of application No. PCT/JP2020/007685, filed on Feb. 26, 2020.

(30) Foreign Application Priority Data
Mar. 6, 2019 (JP) 2019-040859

(51) Int. Cl. B23B 27/20

(52) U.S. Cl. CPC B23B 27/20; B23B 2228/10; B23B 2226/31

(57) ABSTRACT

In a diamond-coated tool, a flank face of a tool base material includes a first flank face continuously extending to a cutting edge, a second flank face located farther away from the cutting edge than the first flank face and located outside the first flank face when viewed from an inside of the tool base material, and a flank face-side stepped portion connecting the first flank face and the second flank face. A diamond-coated layer is provided on the first flank face and the flank face-side stepped portion.

### CROSS REFERENCE TO RELATED APPLICATIONS

This application is a continuation application of application No. PCT/JP2020/007685, filed on Feb. 26, 2020, and claims the benefit of priority from Japanese Patent Application No. 2019-040859, filed on Mar. 6, 2019 and the entire contents of which are incorporated herein by reference.

### BACKGROUND

The present disclosure relates to a diamond-coated tool obtained by diamond-coating a tool base material.

In the related art, tools obtained by diamond-coating a cemented carbide insert base material are used for cutting hard materials such as ceramics, cemented carbide, and carbon fiber reinforced plastic (CFRP). Single-crystalline diamond tools or polycrystalline diamond tools are also used for cutting such hard materials, but due to their high cost, diamond-coated tools have a significant advantage in terms of cost.

JP H06-335806 A discloses a throw-away insert obtained by diamond-coating an insert base material. In such a throw-away insert, in order to prevent a cutting edge of a coated layer from being damaged when a coated rake face is held by a clamping means, a portion, near the cutting edge, of the rake face of the insert base material is lowered one step relative to a center portion of the rake face.

FIG. 1 shows a structure of a portion around a cutting edge of a diamond-coated tool 50 known in the related art. The diamond-coated tool 50 is manufactured by diamond-coating a portion around a cutting edge 53 of a tool base material 51 made of cemented carbide and has a diamond-coated layer 52 provided on the cutting edge 53, a rake face 54, and a flank face 55 of the tool base material 51. In FIG. 1, an X-axis direction represents a cutting thickness direction during a cutting process with the diamond-coated tool 50, and a Y-axis direction represents a cutting direction during the cutting process.

When adhesion between the tool base material 51 and the diamond-coated layer 52 in the diamond-coated tool 50 is not high, and a workpiece has ultra-high hardness or a cutting force increases due to an increase in wear on the cutting edge, the diamond-coated layer 52 tends to separate off from the tool base material 51.

Examples of the measures to be taken to solve this problem include adjusting the composition of the cemented carbide (for example, reducing the proportion of Co serving as a binder), and increasing the surface roughness of the base material to bring about an anchor effect, but such measures are not adequate for solving the problem, and the separation problem still remains.

### SUMMARY

The present disclosure has been made in view of such circumstances, and it is therefore an object of the present disclosure to provide a structure for suppressing separation of a diamond-coated layer from a tool base material in a diamond-coated tool.

In order to solve the above-described problem, one aspect of the present disclosure relates to a diamond-coated tool obtained by diamond-coating a tool base material including a rake face, a flank face, and a cutting edge serving as a boundary between the rake face and the flank face. In the diamond-coated tool according to this aspect, the flank face of the tool base material includes a first flank face continuously extending to the cutting edge, a second flank face located farther away from the cutting edge than the first flank face and located outside the first flank face when viewed from an inside of the tool base material, and a flank face-side stepped portion connecting the first flank face and the second flank face. The diamond-coated layer is provided on the cutting edge, the first flank face, and the flank face-side stepped portion.

Another aspect of the present disclosure relates to a diamond-coated tool obtained by diamond-coating a tool base material including a rake face, a flank face, and a cutting edge serving as a boundary between the rake face and the flank face. In the diamond-coated tool according to this aspect, the rake face of the tool base material includes a first rake face continuously extending to the cutting edge, a second rake face located farther away from the cutting edge than the first rake face and located outside the first rake face when viewed from an inside of the tool base material, and a rake face-side stepped portion connecting the first rake face and the second rake face. The diamond-coated layer is provided on the first rake face and the rake face-side stepped portion, and the rake face of the diamond-coated tool is made flat.

### BRIEF DESCRIPTION OF THE DRAWINGS

FIG. 1 is a diagram showing a structure around a cutting edge of a diamond-coated tool known in the related art;

FIG. 2 is a diagram showing a shape of a tool base material according to an embodiment;

FIG. 3 is an enlarged cross-sectional view of a flank face-side stepped portion;

FIG. 4 is a diagram showing a structure of a diamond-coated tool;

FIG. 5 is a diagram showing another example of the structure of the diamond-coated tool; and

FIG. 6 is a diagram showing yet another example of the structure of the diamond-coated tool.

### DETAILED DESCRIPTION

The disclosure will now be described by reference to the preferred embodiments. This does not intend to limit the scope of the present disclosure, but to exemplify the disclosure.

A description will be given below of a diamond-coated tool according to the embodiment.

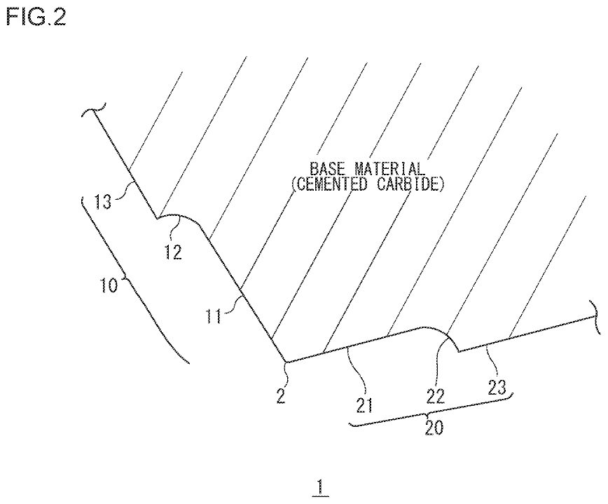

FIG. 2 shows a shape of a tool base material 1 according to the embodiment. The tool base material 1 includes a rake face 10, a flank face 20, and a cutting edge 2 serving as a boundary between the rake face 10 and the flank face 20. The diamond-coated tool is manufactured by diamond-coating a portion around the cutting edge 2 of the tool base material 1.

The flank face 20 of the tool base material 1 includes a first flank face 21 continuously extending to the cutting edge 2, a second flank face 23 located farther away from the cutting edge 2 than the first flank face 21, and a flank face-side stepped portion 22 connecting the first flank face 21 and the second flank face 23. When viewed from the inside of the tool base material 1, the second flank face 23 is located outside the first flank face 21. In other words, when the first flank face 21 and the second flank face 23 are viewed in their respective orthogonal directions from the inside of the tool base material 1, the second flank face 23 is located on a side larger in cutting part thickness than the first flank face 21. The first flank face 21 and the second flank face 23 may be provided as planate or flat surfaces and be approximately parallel to each other. For example, the first flank face 21 and the flank face-side stepped portion 22 may be provided by cutting out the second flank face 23 provided as a planate or flat surface extending up to the cutting edge.

The rake face 10 of the tool base material 1 includes a first rake face 11 continuously extending to the cutting edge 2, a second rake face 13 located farther away from the cutting edge 2 than the first rake face 11, and a rake face-side stepped portion 12 connecting the first rake face 11 and the second rake face 13. When viewed from the inside of the tool base material 1, the second rake face 13 is located outside the first rake face 11. In other words, when the first rake face 11 and the second rake face 13 are viewed in their respective orthogonal directions from the inside of the tool base material 1, the second rake face 13 is located on a side larger in cutting part thickness than the first rake face 11. The first rake face 11 and the second rake face 13 may be provided as planate or flat surfaces and be approximately parallel to each other. For example, the first rake face 11 and the rake face-side stepped portion 12 may be provided by cutting out the second rake face 13 provided as a planate or flat surface extending up to the cutting edge.

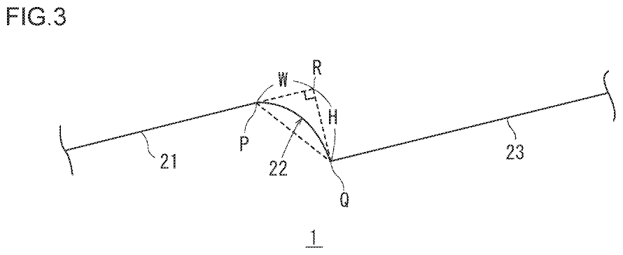

FIG. 3 is an enlarged cross-sectional view of the flank face-side stepped portion. As shown in FIG. 3, a boundary P between the flank face-side stepped portion 22 and the first flank face 21 and a boundary Q between the flank face-side stepped portion 22 and the second flank face 23 are defined. An inclined surface of the flank face-side stepped portion 22 may be a plane connecting the boundary P and the boundary Q, but as shown in FIG. 3, the inclined surface may be located on a deep side relative to the plane connecting the boundary P and the boundary Q when viewed from the outside of the tool base material 1 (specifically, the inclined surface of the flank face-side stepped portion 22 may be concave relative to the plane connecting the boundary P and the boundary Q when viewed from the outside of the tool base material 1).

When an intersection point between an imaginary surface extending from the first flank face 21 toward the inside of the tool base material 1 and a perpendicular line drawn from the boundary Q is denoted by R, a distance W between the boundary P and the intersection point R is preferably smaller than a distance H between the boundary Q and the intersection point R. Specifically, in FIG. 3, it is preferable that an angle formed by a line segment PR and a line segment PQ be equal to or greater than 45 degrees. Further, when the inclined surface of the flank face-side stepped portion 22 is concave relative to the plane connecting the boundary P and the boundary Q, it is preferable that an angle formed by the line segment PR and a tangent to the concave shape at a point near the boundary Q be approximately equal to 90 degrees. Note that a structure may be employed where the boundary P is located near the intersection point R, the angle formed by the line segment PR and the line segment PQ is approximately equal to 90 degrees, and the flank face-side stepped portion 22 is a wall surface approximately perpendicular to the first flank face 21.

Note that FIG. 3 shows the structure of the flank face-side stepped portion 22 provided on the flank face 20, but the rake face-side stepped portion 12 provided on the rake face 10 may be the same in structure as the flank face-side stepped portion 22 shown in FIG. 3.

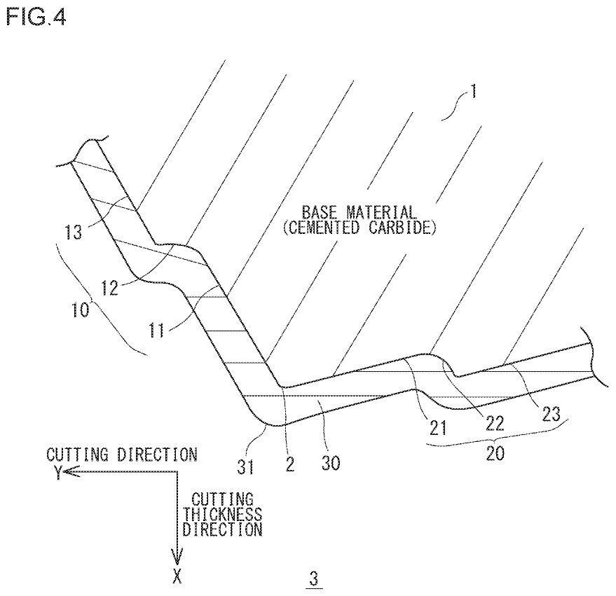

FIG. 4 shows a structure of a diamond-coated tool 3 obtained by diamond-coating the tool base material 1. A diamond-coated layer 30 is provided on the cutting edge 2, the rake face 10, and the flank face 20 of the tool base material 1. A cutting part 31 having a radius approximately equal to a layer thickness is provided at the cutting edge 2 of the tool base material 1. The layer thickness of the diamond-coated layer 30 is preferably equal to or smaller than the distance H (see FIG. 3). In FIG. 4, the X-axis direction represents a cutting thickness direction during a cutting process with the diamond-coated tool 3, and the Y-axis direction represents a cutting direction during the cutting process.

On the flank face 20, the diamond-coated layer 30 is provided on at least the first flank face 21 and the flank face-side stepped portion 22. Herein, providing the diamond-coated layer 30 on the first flank face 21 and the flank face-side stepped portion 22 corresponds to bringing the diamond-coated layer 30 into close contact with the first flank face 21 and the flank face-side stepped portion 22.

When the cutting part 31 receives a cutting force from a workpiece during the cutting process with the diamond-coated tool 3, the diamond-coated layer 30 provided on the flank face 20 receives a shearing load, produced by the cutting force, in the extending direction of the first flank face 21. At this time, the flank face-side stepped portion 22 serves as a separation suppressing structure that suppresses shear separation between the first flank face 21 and the diamond-coated layer 30 caused by receiving the shearing load applied to the diamond-coated layer 30.

On the rake face 10, the diamond-coated layer 30 is provided on at least the first rake face 11 and the rake face-side stepped portion 12. Herein, providing the diamond-coated layer 30 on the first rake face 11 and the rake face-side stepped portion 12 corresponds to bringing the diamond-coated layer 30 into close contact with the first rake face 11 and the rake face-side stepped portion 12.

During the cutting process with the diamond-coated tool 3, the diamond-coated layer 30 provided on the rake face 10 receives a shearing load, produced by the cutting force, in the extending direction of the first rake face 11. At this time, the rake face-side stepped portion 12 serves as a separation suppressing structure that suppresses shear separation between the first rake face 11 and the diamond-coated layer 30 caused by receiving the shearing load applied to the diamond-coated layer 30.

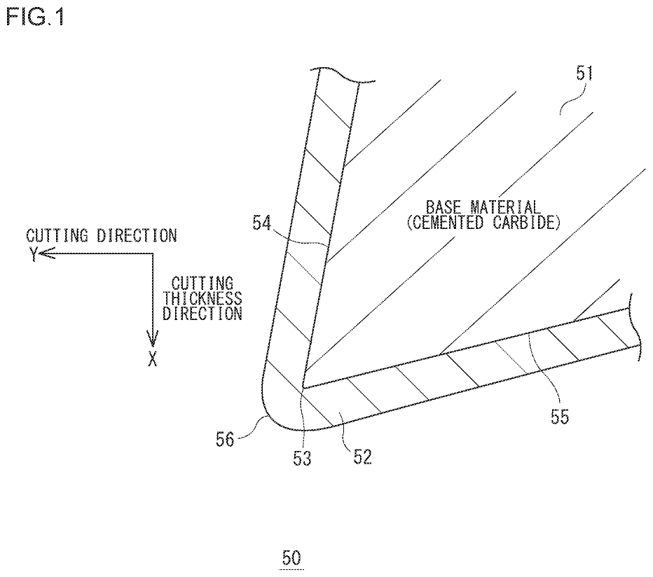

Note that, in order to cut a high-hardness workpiece, with a cutting edge strength taken into consideration, cutting process is performed usually with a cutting thickness smaller than the thickness of the coated layer (that is, smaller than the round radius of the cutting edge of a typical coated tool). In such cutting process, an actual rake angle is often determined by the round radius of the cutting edge and the cutting thickness, but the diamond-coated tool 3 according to the embodiment may be formed such that a designed rake angle becomes a negative angle. When the designed rake angle is a positive angle (see FIG. 1), the direction of the cutting force applied to the cutting part 31 and the extending direction of the rake face 10 are close to each other, so that the shearing load produced by the cutting force becomes large. On the other hand, when the designed rake angle is a negative angle, a difference between the direction of the cutting force and the extending direction of the rake face 10 becomes large, so that the shearing load produced by the cutting force becomes small. Therefore, in the diamond-coated tool 3 according to the embodiment, setting the cutting edge angle (cutting tool angle) of the tool base material 1 equal to or greater than 90 degrees makes the designed rake angle negative to reduce the shearing load applied, in a direction parallel to the rake face 10, between the diamond-coated layer 30 and the tool base material 1.

In the diamond-coated tool 3 according to the embodiment, the separation suppressing structure is provided on at least the flank face 20. Providing the separation suppressing structure on the flank face 20 makes it possible to suppress shear separation of the diamond-coated layer 30 on the flank face 20. When the separation suppressing structure is provided on only the flank face 20, it is preferable that the diamond-coated tool 3 be used such that the designed rake angle becomes a negative angle as described above. Note that the separation suppressing structure may be further provided on the rake face 10.

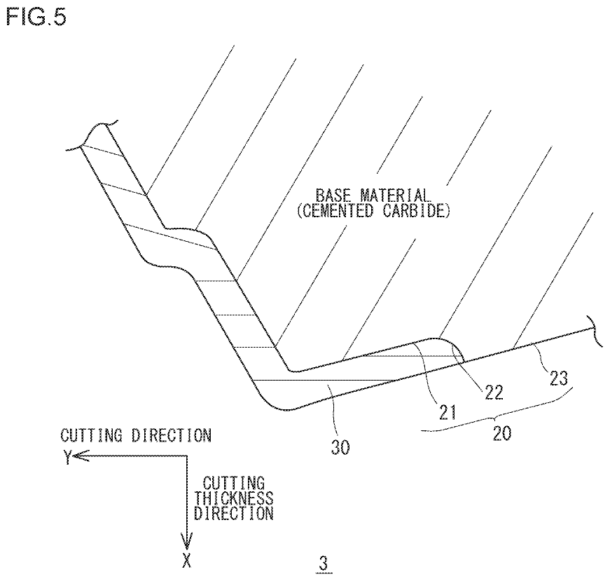

FIG. 5 shows another example of the structure of the diamond-coated tool 3. A diamond-coated layer 30 is provided on the cutting edge 2, the rake face 10, and the flank face 20 of the tool base material 1. In FIG. 5, the X-axis direction represents a cutting thickness direction during the cutting process with the diamond-coated tool 3, and the Y-axis direction represents a cutting direction during the cutting process.

On the flank face 20, the diamond-coated layer 30 is provided on the first flank face 21 and the flank face-side stepped portion 22, but is not provided on the second flank face 23. With reference to FIG. 4, when diamond-coating is applied to the second flank face 23, a convex portion of the diamond-coated layer 30 protruding in the cutting thickness direction is formed near the boundary between the flank face-side stepped portion 22 and the second flank face 23. This convex portion may come into contact with a finished surface of the workpiece; therefore, in the diamond-coated tool 3 shown in FIG. 5, no diamond-coated layer 30 is provided on the second flank face 23 to prevent the convex portion from being formed.

Therefore, in the manufacturing process of the diamond-coated tool 3, before the coating process, a predetermined preprocessing may be performed to prevent the second flank face 23 from being coated with diamond. As another manufacturing procedure, after the diamond-coated layer 30 is formed on the flank face 20 by the coating process, the diamond-coated layer 30 formed on the second flank face 23 may be eliminated. In this elimination process, the diamond-coated layer 30 may be eliminated, to the extent of not coming into contact with the finished surface of the workpiece, and it is not necessary to eliminate all of the diamond-coated layer 30 formed on the second flank face 23.

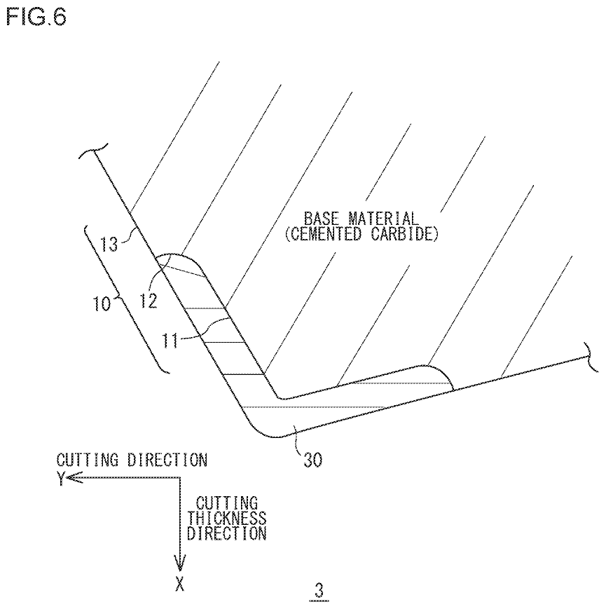

FIG. 6 shows yet another example of the structure of the diamond-coated tool 3. A diamond-coated layer 30 is provided on the cutting edge 2, the rake face 10, and the flank face 20 of the tool base material 1. In FIG. 6, the X-axis direction represents a cutting thickness direction during the cutting process with the diamond-coated tool 3, and the Y-axis direction represents a cutting direction during the cutting process.

On the rake face 10, the diamond-coated layer 30 is provided on the first rake face 11 and the rake face-side stepped portion 12, but is not provided on the second rake face 13. With reference to FIG. 5, when diamond-coating is applied to the second rake face 13, a portion of the diamond-coated layer 30 around the rake face-side stepped portion 12 protrudes outward. This shape may hinder the outflow of chips, and therefore, in the diamond-coated tool 3 shown in FIG. 6, the diamond-coated layer 30 is not provided on the second rake face 13 to make the diamond-coated layer 30 on the first rake face 11 and the rake face-side stepped portion 12 flush with the second rake face 13. Note that the structure where the diamond-coated layer 30 and the second rake face 13 are flush with each other includes a structure where the diamond-coated layer 30 and the second rake face 13 are connected, to the extent of not hindering the outflow of chips and are approximately flush with each other.

In the manufacturing process of the diamond-coated tool 3, after being formed on the rake face 10, the diamond-coated layer 30 may be eliminated to make the rake face of the diamond-coated tool 3 flat. At this time, as shown in FIG. 6, all of the diamond-coated layer 30 provided on the second rake face 13 may be eliminated, but the elimination of the diamond-coated layer 30 is performed to make the rake face of the diamond-coated tool 3 flat so as not to hinder the outflow of chips; therefore, the diamond- coated layer 30 may remain on the second rake face 13.

The present disclosure has been described on the basis of the embodiment. It is to be understood by those skilled in the art that the embodiment is illustrative and that various modifications are possible for a combination of components or processes, and that such modifications are also within the scope of the present disclosure.

An outline of aspects of the present disclosure is as follows. One aspect of the present disclosure relates to a diamond-coated tool obtained by diamond-coating a tool base material including a rake face, a flank face, and a cutting edge serving as a boundary between the rake face and the flank face. In this diamond-coated tool, the flank face of the tool base material includes a first flank face continuously extending (connected) to the cutting edge, a second flank face located farther away from the cutting edge than the first flank face and located outside the first flank face when viewed from an inside of the tool base material, and a flank face-side stepped portion connecting the first flank face and the second flank face. The diamond-coated layer may be provided on the cutting edge, the first flank face, and the flank face-side stepped portion.

According to this aspect, the flank face-side stepped portion serves as a separation suppressing structure to suppress separation of the diamond-coated layer on the flank face.

The rake face of the tool base material includes a first rake face continuously extending (connected) to the cutting edge, a second rake face located farther away from the cutting edge than the first rake face and located outside the first rake face when viewed from the inside of the tool base material, and a rake face-side stepped portion connecting the first rake face and the second rake face. The diamond-coated layer may be provided on the first rake face and the rake face-side stepped portion. In this structure, the rake face-side stepped portion serves as a separation suppressing structure to suppress separation of the diamond-coated layer on the rake face.

Another aspect of the present disclosure relates to a diamond-coated tool obtained by diamond-coating a tool base material including a rake face, a flank face, and a cutting edge serving as a boundary between the rake face and the flank face. In this diamond-coated tool, the rake face of the tool base material includes a first rake face continuously extending (connected) to the cutting edge, a second rake face located farther away from the cutting edge than the first rake face and located outside the first rake face when viewed from an inside of the tool base material, and a rake face-side stepped portion connecting the first rake face and the second rake face. The diamond-coated layer is provided on the first rake face and the rake face-side stepped portion, and the rake face of the diamond-coated tool is made flat.

According to this aspect, the rake face-side stepped portion serves as a separation suppressing structure to suppress separation of the diamond-coated layer on the rake face, and the rake face after the diamond-coating is made flat to allow chips to flow out smoothly. The diamond-coated layer need not be provided on the second rake face.

A shearing load applied to the diamond-coated layer on the rake face may be reduced by setting an angle of the cutting edge equal to or larger than 90 degrees and setting a designed rake angle to a negative angle.

What is claimed is:

1. A diamond-coated tool obtained by diamond-coating a tool base material including a rake face, a flank face, and a cutting edge serving as a boundary between the rake face and the flank face, wherein
the flank face of the tool base material includes a first flank face that continuously extends to the cutting edge, a second flank face that is located farther away from the cutting edge than the first flank face and located outside the first flank face when viewed from an inside of the tool base material, and a flank face-side stepped portion connecting the first flank face and the second flank face, and
a diamond-coated layer is provided on the cutting edge, the first flank face, and the flank face-side stepped portion.

2. The diamond-coated tool according to claim 1, wherein
the rake face of the tool base material includes a first rake face continuously extending to the cutting edge, a second rake face located farther away from the cutting edge than the first rake face and located outside the first rake face when viewed from the inside of the tool base material, and a rake face-side stepped portion connecting the first rake face and the second rake face, and
the diamond-coated layer is provided on the first rake face and the rake face-side stepped portion.

3. A diamond-coated tool obtained by diamond-coating a tool base material including a rake face, a flank face, and a cutting edge serving as a boundary between the rake face and the flank face, wherein
the rake face of the tool base material includes a first rake face that continuously extends to the cutting edge, a second rake face that is located farther away from the cutting edge than the first rake face and located outside the first rake face when viewed from an inside of the tool base material, and a rake face-side stepped portion connecting the first rake face and the second rake face, and
a diamond-coated layer is provided on the first rake face and the rake face-side stepped portion, and the rake face of the diamond-coated tool is made flat.

4. The diamond-coated tool according to claim 3, wherein
the diamond-coated layer is not provided on the second rake face.

5. The diamond-coated tool according to claim 1, wherein
an angle of the cutting edge is equal to or larger than 90 degrees.

6. The diamond-coated tool according to claim 2, wherein
an angle of the cutting edge is equal to or larger than 90 degrees.

7. The diamond-coated tool according to claim 3, wherein
an angle of the cutting edge is equal to or larger than 90 degrees.

8. The diamond-coated tool according to claim 4, wherein
an angle of the cutting edge is equal to or larger than 90 degrees.

9. A diamond-coated tool obtained by diamond-coating a tool base material including a rake face, a flank face, and a cutting edge serving as a boundary between the rake face and the flank face, wherein
the flank face of the tool base material includes a first flank face that is planate and continuously extends to the cutting edge, a second flank face that is planate and is located farther away from the cutting edge than the first flank face and located outside the first flank face when viewed from an inside of the tool base material, and a flank face-side stepped portion connecting the first flank face and the second flank face, and
a diamond-coated layer is provided on the cutting edge, the first flank face, and the flank face-side stepped portion.

10. The diamond-coated tool according to claim 9, wherein
the rake face of the tool base material includes a first rake face continuously extending to the cutting edge, a second rake face located farther away from the cutting edge than the first rake face and located outside the first rake face when viewed from the inside of the tool base material, and a rake face-side stepped portion connecting the first rake face and the second rake face, and
the diamond-coated layer is provided on the first rake face and the rake face-side stepped portion.

11. A diamond-coated tool obtained by diamond-coating a tool base material including a rake face, a flank face, and a cutting edge serving as a boundary between the rake face and the flank face, wherein
the rake face of the tool base material includes a first rake face that is planate and continuously extends to the cutting edge, a second rake face that is planate and is located farther away from the cutting edge than the first rake face and located outside the first rake face when viewed from an inside of the tool base material, and a rake face-side stepped portion connecting the first rake face and the second rake face, and
a diamond-coated layer is provided on the first rake face and the rake face-side stepped portion, and the rake face of the diamond-coated tool is made flat.

12. The diamond-coated tool according to claim 11, wherein
the diamond-coated layer is not provided on the second rake face.

13. The diamond-coated tool according to claim 9, wherein
an angle of the cutting edge is equal to or larger than 90 degrees.

14. The diamond-coated tool according to claim 10, wherein
an angle of the cutting edge is equal to or larger than 90 degrees.

15. The diamond-coated tool according to claim 11, wherein
an angle of the cutting edge is equal to or larger than 90 degrees.

16. The diamond-coated tool according to claim 12, wherein
an angle of the cutting edge is equal to or larger than 90 degrees.
